(19) United States
(12) Patent Application Publication
(10) Pub. No.: US 2014/0050315 A1
(43) Pub. Date: Feb. 20, 2014

(54) HIGH-SPEED IN-MEMORY QR DECOMPOSITION USING FAST PLANE ROTATIONS

(71) Applicant: XW, LLC D/B/A XTENDWAVE, (US)

(72) Inventors: Aditya Awasthi, Richardson, TX (US); Zahid Islam, Dallas, TX (US); Naofal M. Al-Dhahir, Plano, TX (US); Oren E. Eliezer, Plano, TX (US); Dennis I. Robbins, Richardson, TX (US)

(73) Assignee: XW, LLC D/B/A XTENDWAVE, Dallas, TX (US)

(21) Appl. No.: 13/761,012

(22) Filed: Feb. 6, 2013

Related U.S. Application Data
(60) Provisional application No. 61/595,567, filed on Feb. 6, 2012.

(51) Int. Cl. H04B 7/04; H04B 3/32

(52) U.S. Cl. CPC H04B 7/0456; H04B 3/32
USPC 379/406.02; 375/349; 375/296

(57) ABSTRACT

A system and method for processing an input matrix and a MIMO receiver employing the system or the method. In one embodiment, the system includes: (1) a transformer configured to receive a frame of complex data representing only some elements of an input matrix and perform a fast plane rotation on the complex data to yield rotated data and (2) a matrix updater coupled to the transformer and configured to update a memory configured to contain an output matrix with the rotated data. In one embodiment, the system and method are to estimate and mitigate alien cross-talk experienced in a vectored DSL communication system.

### CROSS-REFERENCE TO RELATED APPLICATION

This application claims the benefit of U.S. Provisional Application Ser. No. 61/595,567, filed by Awasthi, et al., on Feb. 6, 2012, entitled “High-Speed In-Memory OR [sic.] Decomposition Using Fast Plane Rotations,” commonly assigned with this application and incorporated herein by reference.

### TECHNICAL FIELD

This application is directed, in general, to QR decomposition and, more specifically, to a system and method for performing QR decomposition and a multiple-input, multiple-output MIMO receiver employing the system or the method.

### BACKGROUND

MIMO techniques have been widely adopted to increase the data transmission rate or improve the quality of services (QoS) in recent wireless and wired communication systems. MIMO signal processing plays a key role in both the performance as well as implementation complexity, and attracts much attention in system design. Matrix inversion or triangularization is often required to deal with MIMO's multi-dimensional signals, and QR decomposition (QRD) is an essential signal processing step in it.

QRD is the decomposition of a matrix into an orthogonal matrix and a triangular matrix. The QRD of a real square matrix A is defined as:

A=QR,

where Q is an orthogonal matrix (i.e., Q^{T} Q=I), and R is an upper triangular matrix. This generalizes to a complex square matrix A and a unitary matrix Q. If A is invertible, and the diagonal elements of R are required to be positive, the factorization is unique.

In the context of MIMO, QRD has been used in the precoder of a transmitter to convert one MIMO-OFDM channel into layered subchannels. It is also used to pre-process the signal to be detected by MIMO sphere decoders. In fact, QRD can be employed to perform MIMO signal detection itself. In the context of Digital Subscriber Lines (DSL), QRD is used, for example, to mitigate alien crosstalk between various line-pair combinations. Outside of communication applications, QRD finds general use in, among other things, determining the eigenvalues of a matrix, solving linear systems and making least-squares approximations.

### SUMMARY

A system for processing an input matrix. In one embodiment, the system includes: (1) a transformer configured to receive a frame of complex data representing only some elements of an input matrix and perform a fast plane rotation on the complex data to yield rotated data and (2) a matrix updater coupled to the transformer and configured to update a memory configured to contain an output matrix with the rotated data.

Another aspect provides a method of processing an input matrix. In one embodiment, the method includes: (1) receiving a frame of complex data representing only some elements of an input matrix, (2) performing a fast plane rotation on the complex data to yield rotated data and (3) updating a memory configured to contain an output matrix with the rotated data.

Yet another aspect provides a MIMO receiver. In one embodiment, the MIMO receiver includes a receive chain including alien crosstalk mitigation circuitry having a spatial correlation estimator and an alien crosstalk canceller, configured to receive a frame of complex data representing only some elements of an input matrix. In one embodiment, the alien crosstalk mitigation circuitry includes: (1) an initial decomposer configured to compute an initial upper-triangular matrix and cause the initial upper-triangular matrix to be stored in a memory as an output matrix, (2) a transformer configured to perform a fast plane rotation on the complex data to yield rotated data and (3) a matrix updater coupled to the transformer and configured to update the memory with the rotated data.

Still another aspect provides a MIMO transmitter. In one embodiment, the MIMO transmitter includes a transmit chain configured to receive a frame of complex data representing only some elements of an input matrix. In one embodiment, the transmit chain includes: (1) a transformer configured to perform a fast plane rotation on the complex data to yield rotated data and (2) a matrix updater coupled to the transformer and configured to update a memory configured to contain an output matrix with the rotated data.

### BRIEF DESCRIPTION

Reference is now made to the following descriptions taken in conjunction with the accompanying drawings, in which:

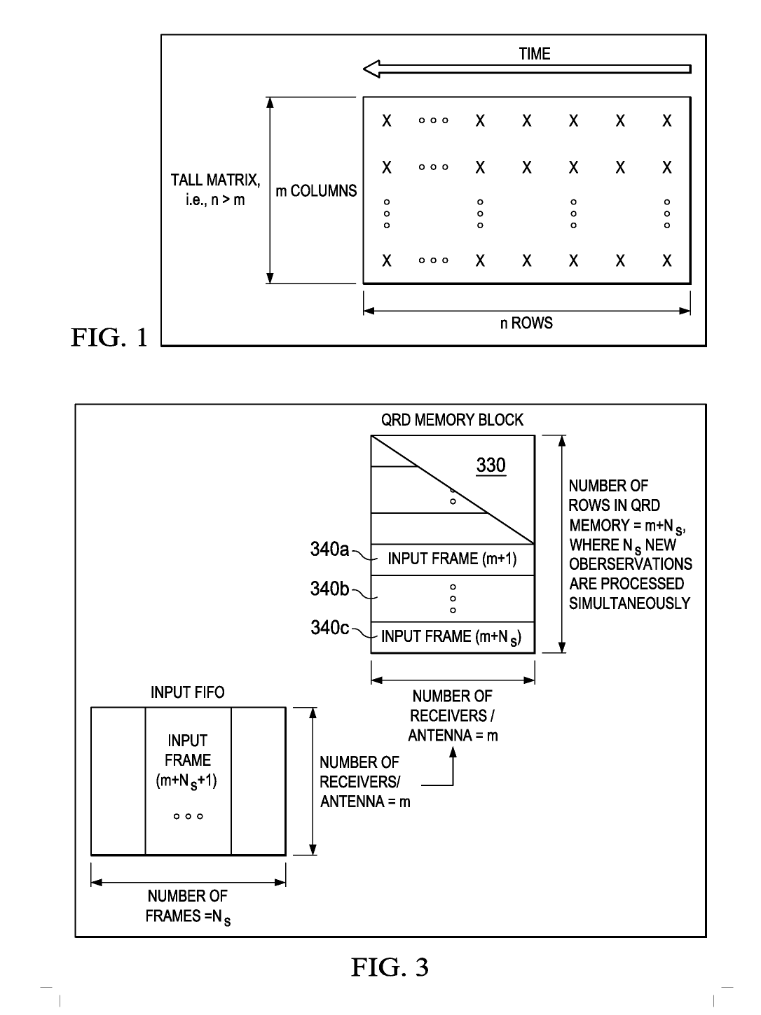

FIG. 1 is a diagram of a typical input matrix for QRD in MIMO communications;

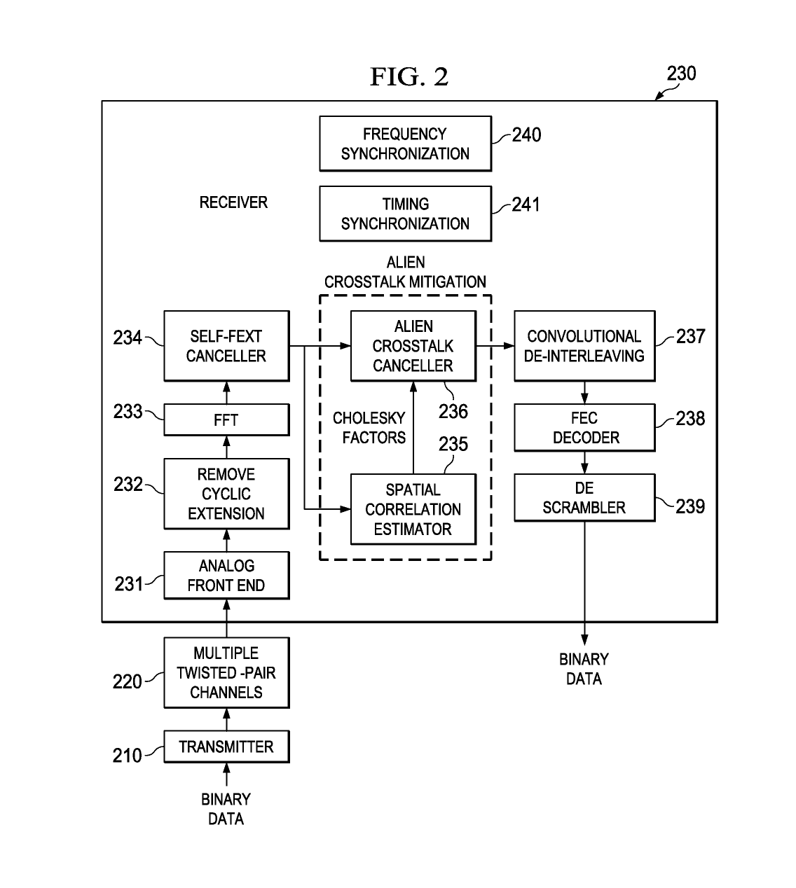

FIG. 2 is a block diagram of one embodiment of a DMT-based vectored DSL system including alien crosstalk mitigation circuitry;

FIG. 3 is a block diagram of one embodiment of an input first-in, first-out (FIFO) buffer and associated QRD memory block;

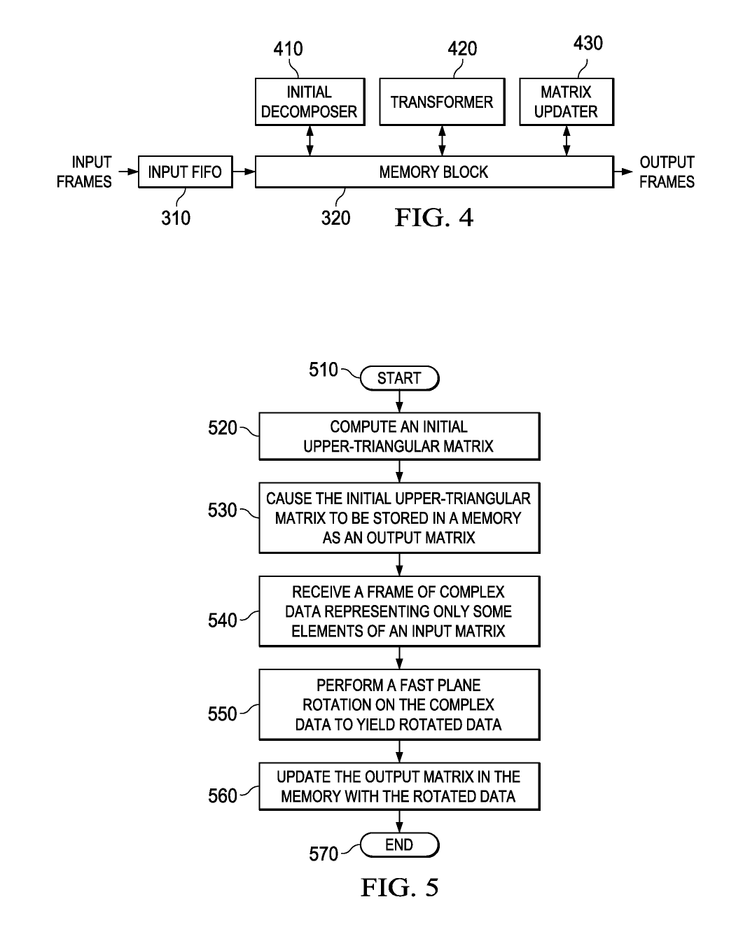

FIG. 4 is a block diagram of one embodiment of a system for processing an input matrix; and

FIG. 5 is a flow diagram of one embodiment of a method of processing an input matrix.

### DETAILED DESCRIPTION

As established above, QRD has wide-ranging application. In fact, a high-throughput QRD system or method is necessary to meet the demands of modern transmission rates. However, decomposing a complex matrix with large dimensions into an upper triangular matrix is difficult to perform in real-time due to large memory requirements and high computational complexity.

In many communication applications, the QRD input matrix A is obtained from the data observed at the receiver over successive time intervals; the rows of the input matrix arrive sequentially in time. FIG. 1 is a diagram of a typical input matrix for QRD in MIMO communications and illustrates this point. An input matrix 100 is illustrated as having n rows and m columns of elements. As is common in MIMO, n>m. The elements of the matrix 100 are shaded to represent a typical order in which they arrive over time; elements that are shaded lighter arrive earlier than elements that are shaded darker.

Furthermore, the accuracy requirements of known estimation algorithms employing QRD can only be achieved by processing a large number of observations (e.g., received data from multiple time intervals). Thus, the total number of observations is usually much greater than number of antennas or receivers, which can lead to impractical memory requirements.

Introduced herein are various embodiments of a system and method for performing QRD using fast plane rotations and a vectored DSL transceiver employing the system or method. In various embodiments to be illustrated and described herein, the fast plane rotations are employed to update frames of matrix elements that arrive over time and are stored in a relatively small, fast memory block. For this reason, the QRD techniques described herein will be called “In-Memory Fast Plane Rotation updating,” or IMFPU. However, those skilled in the pertinent art will understand that the novel techniques are intended to operate in a wide variety of computing environments, including those outside signal processing or communications.

First, a technique for performing complex fast plane rotations will be introduced. The complex fast rotation algorithm incorporates dynamic scaling to prevent underflow or overflow and have reduced number of square root and multiplication operations present in conventional real techniques (see, e.g., Anda, et al., “Fast Plane Rotations With Dynamic Scaling,” SIAM J. Matrix Anal. Appl., vol. 15, pp. 162-174, January 1994, and, Golub, et al., Matrix Computations, Johns Hopkins University Press, Baltimore, Md., USA, 1996).

The novel technique may be employed with a systolic array architecture, allowing a large matrix to be processed in parallel. Then, a special sequence of complex fast plane rotations will be described that allows high-speed incremental QRD computations to be performed on large number of inputs arriving sequentially over time, eliminating the need to store large amounts of data in memory. One application of the novel technique is provided in the context of alien crosstalk spatial-correlation in a vectored VDSL system to illustrate the suitability of the novel technique to very-large-scale integrated circuit (VLSI) implementation for MIMO systems, among other things.

QRD Using IMFPU

All conventional QRD techniques based on Householder reflections or Givens rotations of which the inventors hereof are aware involve computation operations along multiple rows of the input matrix (see, e.g., Golub, et al., sections 5.2.1 and 5.2.3, supra). Any operation or sequence of operations that use elements from multiple rows (i.e., data received at different time instances) would lead to significant increase in memory requirements, since data received over time needs to be accumulated (stored) before processing can begin. Further, Householder and Givens transformations involve square roots and multiple division operations, which can make the implementation of QRD prohibitively complex and impractical, particularly in high data-rate applications.

Fast plane rotations (also known as “Fast Givens” transformations) have the dual advantages of requiring fewer multiplications when the inputs are real numbers and being free of square-root operations. Table 1, below, sets forth example pseudocode for one embodiment of a novel Fast Givens transform that accommodates complex fast plane rotations.

TABLE 1
Pseudocode Embodiment for a Novel, Complex Fast Givens
Transform

| | |
|---|---|
| Input: f, g, d_{f}, d_{g} | |
| Output: α, β, r, type, d_{f}^{new}, d_{g}^{new} | |
| if (real(g) == 0)&&(imag(g) == 0) then | /* g is zero */ |
| type=1; | |
| α=β=0; r=f; | |
| d_{f}^{new} =d_{f} and d_{g}^{new} =d_{g}; | |
| else if (real(f) == 0)&&(imag(f) == 0) then | /* f is zero (and g ≠ 0) */ |
| type=0; | |
| α=β=0; r=g; | |
| d_{f}^{new} =d_{g} and d_{g}^{new} =d_{f}; | |
| else if \|\|f\|\|² ≦ \|\|g\|\|² then | /* If \|f/g\| ≦ 1 */ |
| type=0; | |
| iratio=f/g; sratio=d_{g}/d_{f}; | |
| α=−1 * ctranspose(iratio); β=sratio * | |
| iratio; | |
| γ=sratio * abs(iratio)²; r=g * (1 + γ); | |
| d_{f}^{new} =(1 + γ) * d_{g} and d_{g}^{new} =(1 + γ) * d_{f}; | |
| else /* If \|f/g\| > 1 */ | |
| type=1; | |
| iratio=g/f; sratio=d_{f}/d_{g}; | |
| α=−1 * ctranspose(iratio); β=sratio * | |
| iratio; | |
| γ=sratio * abs(iratio)²; r=f * (1 + γ); | |
| d_{f}^{new} =(1 + γ) * d_{f} and d_{g}^{new} =(1 + γ) * d_{g}; | |
| end | |

It is realized that fast plane rotations can be not only free of square-root operations but also even more beneficial when inputs are complex numbers. The embodiment of Table 1 incorporates dynamic scaling to prevent underflow or overflow problems inherent in conventional fast rotations (see, e.g., Gentleman, “Least Squares Computations by Givens Transformations Without Square Roots,” IMA Journal of Applied Mathematics, vol. 12(3), pp. 329-336, 1973, and, Hammarling, “A Note on Modifications to the Givens Plane Rotation,” J. Inst. Math Appl., vol. 13, pp. 215-218, 1974).

As stated above, one objective herein is to introduce a novel complex Fast Givens transform that can form the basis for an update-based QRD technique by using an intrinsic characteristic of MIMO communication systems, namely that frames of data constituting matrix rows arrive over time, and not simultaneously, to minimize the overall latency and the silicon area required for memory and computational blocks. The memory requirements and the computation complexity may be significantly reduced by employing a novel QRD based upon IMFPU, in which incremental computations are performed to arrive at final accurate estimates using a reduced number of observations at any given time. In one embodiment, a minimum number of observations is used at any given time.

FIG. 2 is a block diagram of one embodiment of a DMT-based vectored DSL system including alien crosstalk mitigation circuitry. The system includes a transmitter 210 configured to accept binary data and provide a plurality of channels which, in the context of DSL, take the form of twisted-pair channels 220. The transmitter 210 includes a transmit chain (not shown) which, in one embodiment, includes a system or method for processing an input matrix.

A receiver 230 is configured to receive the channels at an end distal from the transmitter 210. The illustrated embodiment of the receiver 230 has a receive chain including an analog front end 231, circuitry 232 to remove cyclic error code extensions, fast Fourier transform circuitry 233 and a self-far-end-crosstalk (FEXT) canceller 234. The receive chain then provides an alien crosstalk mitigation circuit that includes a spatial correlation estimator 235 and an alien crosstalk canceller 236. The alien crosstalk mitigation circuit may be, for example, an embodiment disclosed in U.S. Patent Publication No. US20120093204 by Al-Dhahir, et al., entitled “Processor, Modem and Method for Canceling Alien Noise in Coordinated Digital Subscriber Lines,” which is commonly assigned herewith and incorporated herein by reference.

Following alien crosstalk mitigation, the receive chain includes a convolutional de-interleaving circuit 237, a forward error correction (FEC) decoder 238 and a descrambler 239. To perform its functions, the receive chain makes use of the output of a frequency synchronization circuit 240 and a timing synchronization circuit 241. The receiver 230 provides binary data as its output which, assuming proper operation, is the same as the binary data initially accepted by the transmitter 210.

To illustrate the issues involved in performing QRD in real-time with elements arriving sequentially over time, Profile 17a in ITU-T Recommendation G.993.2, “Very High Speed Digital Subscriber Line Transceivers 2 (VDSL2),” February 2006, may be used as an example of alien crosstalk spatial-correlation for alien interference cancellation in a vectored VDSL2 system. During initialization, spatial correlation estimation using QRD can be performed during either the “training” or the “channel analysis and exchange” phases as defined in the VDSL2 initialization procedures, where each phase lasts for a maximum of 10 seconds (40,000 DMT symbols) (see, e.g., Awasthi, et al., “Alien Crosstalk Mitigation in Vectored DSL Systems for Backhaul Applications,” 2012 IEEE Int'l Conf. on Communic. (ICC), pp. 3852-3856, June 2012). Considering the upstream transmission case for 300 vectored DSL lines (each DMT symbol having a typical cyclic prefix length of 640 and a duration of 0.25 ms) containing 1210 frequency subcarriers for upstream transmission.

Assuming the data-path word is a 16-bit complex value (at least 14-bit analog-to-digital converters, or ADCs, typically being used in VDSL modems), the total memory required to store one VDSL Dual Multi-Tone (DMT) symbol for all L_{C}=300 vectored DSL lines is about 1.4 megabyte (MB). Thus, to calculate the spatial correlation estimates using as few as 300 DMT symbols, 415 MB of memory is needed just to store inputs for the QRD step for the spatial correlation estimator 235 of FIG. 2.

An important feature of the novel QRD technique using the complex fast plane rotations is that the entire QRD task can be broken into IMFPU steps, allowing high-speed incremental QRD computations on a large number of inputs arriving sequentially in time. FIG. 3 is a block diagram of one embodiment of an input FIFO buffer 310 and associated QRD memory block 320 and illustrates this point. Once an initial upper triangular matrix R 330 has been computed, observations (input data for QRD) entering the QRD memory block 320 via the FIFO buffer 310 can be processed in small groups, shown as N_{S} rows 340a, 340b, 340c in the QRD memory block 320 of FIG. 3.

Once the upper triangular matrix R 330 has been updated (causing the elements contained in the N_{S} rows 340a, 340b, 340c thereafter to become zeros), additional N_{S} incoming frames of data (e.g., including the row 340d) may then be written into the bottom N_{S} rows 340a, 340b, 340c until all the incoming data used for QRD (i.e., all n rows of FIG. 1) is exhausted.

FIG. 4 is a block diagram of one embodiment of a system for processing an input matrix. FIG. 4 shows the input FIFO 310 and QRD memory block 320 of FIG. 3. The illustrated embodiment of the system includes an initial decomposer 410. The initial decomposer 410 is configured to compute an initial upper-triangular matrix and cause the initial upper-triangular matrix to be stored in the memory block 320 as an output matrix. The illustrated embodiment of the system yet further includes a transformer 420. The transformer 420 is coupled to the initial decomposer 410 and is configured to receive a frame of complex data representing only some elements of an input matrix, either directly from the input FIFO 310 or from the memory block 320, and perform a fast plane rotation on the complex data to yield rotated data. The illustrated embodiment of the system still further includes a matrix updater 430. The matrix updater 430 is coupled to the transformer 420 and configured to update the output matrix contained in the memory block 320 with the rotated data.

Table 2, below, sets forth example pseudocode for one embodiment of a novel, complex Fast Givens QRD technique using IMFPU for the case in which N_{S}=1.

TABLE 2
Pseudocode Embodiment for a Novel, Complex Fast Givens
QRD

```
Input: Rₘ, dₘ
Output: Rₘ^{new} , dₘ^{new}
Step 1: Fetch already-computed L_{c} × L_{c} upper triangular matrix Rₘ, L_{c} × 1 scale factors dₘ
matrix for m^{th} subcarrier.
Step 2: Fetch 1 × L_{c} row-vector noiseₘ of the new noise samples across all L_{c} DSL lines, and
assign dₙₒᵢₛₑ =1.
Step 3: Update Cholesky factors, and output Rₘ^{new} and dₘ^{new} as follows:
If Rₘ contains K (ε [1, L_{c}]) non-zero rows (i.e., at least K DMT symbols have been received
before the new noise sample),
for k ← 1 to K do
    i) Assign f=Rₘ(k, k); g=noiseₘ(1, k); d_{f}=dₘ(k, 1); d_{g}=dₙₒᵢₛₑ;
    ii) Use Complex Fast Givens Transform (Table 1) to calculate: [α, β, Rₘ^{new} (k, k), type, dₘ^{new} (k,
      1), dₙₒᵢₛₑ^{new}]=fastGivens (f, g, d_{f}, d_{g});
    iii) Use α and β calculated in sub-step ii) above to update the rest of the elements of row
      vectors Rₘ(k, :) and noiseₘ based on type:
    switch type do
      case 0
          Rₘ^{new} (k, :)=ctranspose(β) * Rₘ(k, :) + noiseₘ(1, :);
          noiseₘ^{new} (1, :)=ctranspose(α) * noiseₘ(1, :) + Rₘ(k, :);
      case 1
          Rₘ^{new} (k, :)=ctranspose(β) * noiseₘ(1, :) + Rₘ(k, :);
          noiseₘ^{new} (1, :)=ctranspose(α) * Rₘ(k, :) + noiseₘ(1, :);
      endsw
    endsw
endfor
Step 4: Run again for the next used subcarrier
```

Revisiting the previous example, if only N_{S}=1 additional DMT symbols are processed at a time, 1.4×N_{S}=1.4 MB of memory (instead of 415 MB) would be needed to store inputs while processing all 300 DMT symbols. Note that the QRD memory block 320 should complete the entire IMFPU step within N_{S}×0.25×256=64 ms to avoid input memory overflow in this case, since sync DMT symbols arrive at every 0.25×256=64 ms in VDSL2 transmission. Thus, the number of additional symbols, N_{S}, simultaneously processed during each update can be made as small (i.e., decreasing memory requirements) as the implementation of IMFPU could allow operation with N_{S} being as little as one.

Since QRD computations can begin as soon as first inputs are received instead of waiting for all of them, overall system latency is reduced, typically drastically. Furthermore, the memory requirements and computational complexity are much lower since processed inputs are no longer needed after incremental QRD computations based on IMFPU, and can be discarded from memory to make space for new incoming inputs.

FIG. 5 is a flow diagram of one embodiment of a method of processing an input matrix, and specifically of performing QR decomposition on the input matrix. The method begins in a start step 510. In a step 520, an initial upper-triangular matrix is computed. In a step 530, the initial upper-triangular matrix is caused to be stored in a memory as an output matrix. In a step 540, a frame of complex data representing only some elements of an input matrix is received. In a step 550, a fast plane rotation is performed on the complex data to yield rotated data. In a step 560, the output matrix contained in the memory is updated with the rotated data. The method ends in an end step 570.

Those skilled in the art to which this application relates will appreciate that other and further additions, deletions, substitutions and modifications may be made to the described embodiments.

What is claimed is:

1. A system for processing an input matrix, comprising:
a transformer configured to receive a frame of complex data representing only some elements of an input matrix and perform a fast plane rotation on said complex data to yield rotated data; and
a matrix updater coupled to said transformer and configured to update a memory configured to contain an output matrix with said rotated data.

2. The system as recited in claim 1 further comprising an initial decomposer configured to compute an initial upper-triangular matrix and cause said initial upper-triangular matrix to be stored in said memory as said output matrix.

3. The system as recited in claim 2 wherein said initial decomposer, said transformer and said matrix updater cooperate to perform a QR decomposition of said input matrix.

4. The system as recited in claim 1 wherein said transformer is configured to receive multiple frames of complex data over time.

5. The system as recited in claim 1 wherein said transformer is further configured to scale said fast plane rotation dynamically.

6. The system as recited in claim 1 wherein said transformer is further configured to perform said fast plane rotation without creating a temporary vector copy of said frame.

7. The system as recited in claim 1 wherein said matrix updater is further configured to overwrite frames of complex data that said transformer has processed.

8. A method of processing an input matrix, comprising:
receiving a frame of complex data representing only some elements of an input matrix;
performing a fast plane rotation on said complex data to yield rotated data; and
updating a memory configured to contain an output matrix with said rotated data.

9. The method as recited in claim 8 further comprising:
computing an initial upper-triangular matrix; and
causing said initial upper-triangular matrix to be stored in said memory as said output matrix.

10. The method as recited in claim 9 wherein said performing and said updating constitute QR decomposing said input matrix.

11. The method as recited in claim 8 further comprising carrying out said receiving multiple times over time.

12. The method as recited in claim 8 further comprising scaling said fast plane rotation dynamically.

13. The method as recited in claim 8 further comprising performing said fast plane rotation without creating a temporary vector copy of said frame.

14. The method as recited in claim 8 further comprising overwriting processed frames of complex data.

15. A MIMO receiver, comprising:
a receive chain including alien crosstalk mitigation circuitry having a spatial correlation estimator and an alien crosstalk canceller, configured to receive a frame of complex data representing only some elements of an input matrix and including:
an initial decomposer configured to compute an initial upper-triangular matrix and cause said initial upper-triangular matrix to be stored in a memory as an output matrix,
a transformer configured to perform a fast plane rotation on said complex data to yield rotated data, and
a matrix updater coupled to said transformer and configured to update said memory with said rotated data.

16. The MIMO receiver as recited in claim 15 wherein said initial decomposer, said transformer and said matrix updater cooperate to perform a QR decomposition of said input matrix.

17. The MIMO receiver as recited in claim 15 wherein said transformer is configured to receive multiple frames of complex data over time.

18. The MIMO receiver as recited in claim 15 wherein said transformer is further configured to scale said fast plane rotation dynamically.

19. The MIMO receiver as recited in claim 15 wherein said transformer is further configured to perform said fast plane rotation without creating a temporary vector copy of said frame.

20. The MIMO receiver as recited in claim 15 wherein said matrix updater is further configured to overwrite frames of complex data that said transformer has processed.

21. A MIMO transmitter, comprising:
a transmit chain configured to receive a frame of complex data representing only some elements of an input matrix and including:
a transformer configured to perform a fast plane rotation on said complex data to yield rotated data, and
a matrix updater coupled to said transformer and configured to update a memory configured to contain an output matrix with said rotated data.

22. The MIMO transmitter as recited in claim 21 further comprising an initial decomposer configured to compute an initial upper-triangular matrix and cause said initial upper-triangular matrix to be stored in said memory as said output matrix.

23. The MIMO transmitter as recited in claim 22 wherein said initial decomposer, said transformer and said matrix updater cooperate to perform a QR decomposition of said input matrix.

24. The MIMO transmitter as recited in claim 21 wherein said transformer is configured to receive multiple frames of complex data over time.

25. The MIMO transmitter as recited in claim 21 wherein said transformer is further configured to scale said fast plane rotation dynamically.

26. The MIMO transmitter as recited in claim 21 wherein said transformer is further configured to perform said fast plane rotation without creating a temporary vector copy of said frame.

27. The MIMO transmitter as recited in claim 21 wherein said matrix updater is further configured to overwrite frames of complex data that said transformer has processed.
